(19) United States
(12) Patent Application Publication
(10) Pub. No.: US 2026/0265498 A1
(43) Pub. Date: Sep. 10, 2026

(54) POLYPROPYLENE COMPOSITION FOR USE IN HIGH-FREQUENCY RADIO-WAVE APPLICATIONS

(71) Applicant: SABIC Global Technologies B.V., Bergen op Zoom (NL)

(72) Inventors: Suresh Velate, Bengaluru (IN); Pradipta Nayak, Bengaluru (IN); Dhanabalan Anantharaman, Bengaluru (IN)

(21) Appl. No.: 18/868,002

(22) PCT Filed: May 25, 2023
(86) PCT No.: PCT/EP2023/064101

§ 371 Date: Nov. 21, 2024

(30) Foreign Application Priority Data
May 27, 2022 (EP) 22175718.0

(51) Int. Cl. C08K 7/28; C08L 23/14

(52) U.S. Cl. CPC C08K 7/28; C08L 23/14; C08K 2201/003; C08K 2201/004; C08K 2201/014; C08L 2203/20; C08L 2666/06; C08L 2666/18

(57) ABSTRACT

A polypropylene composition for use in high-frequency radio-wave applications of 6 GHz or greater comprises a mixture of a polypropylene and hollow glass bubbles having an average diameter or particle size of from 5 μm to 80 μm. The polypropylene composition further includes at least one of glass fibers having a length of from 0.5 mm to 10 mm and a width or diameter of from 5 μm to 15 μm, aluminum oxide fibers having a length of from 1 mm to 5 mm and a width or diameter of from 1 μm to 30 μm, a cyclic olefin copolymer, and a polycarbonate. The polypropylene composition is prepared by modifying a polypropylene by melt blending the polypropylene with the various materials.

### TECHNICAL FIELD

The invention relates to polypropylene compositions for use in high-frequency radio-wave applications.

### BACKGROUND

The advent of 5G communication technology and related devices has prompted the requirement of low cost and light-weight polymeric materials with low dielectric constant (Dk) and dissipation factor (Df) values, high metal adhesion strength, low coefficient of thermal expansion (CTE), and good mechanical and thermal properties. Currently, FR-4 glass-reinforced epoxy laminate materials are being widely used as the antenna substrate for sub-6 GHz frequency applications. FR-4 laminates are not considered to be suitable for high frequency (i.e., >6 GHz) applications due to the laminate's high Dk (>4) and Df (>0.01) values.

On the other hand, materials such as polytetrafluoroethylene (PTFE), liquid crystal polymer (LCP) and modified polyimide (M-PI) are considered to be suitable materials for higher frequency (>6 GHz) antenna and other sub-segment applications, due to their low Dk and Df values. These materials are very costly, however, and do not meet the light-weight criteria required for the targeted applications, apart from other specific challenges associated with each of these materials. In particular, use of PTFE brings several challenges such as higher system cost, which includes both material and processing costs, and poor metal adhesion, high CTE along the z-axis, and higher density.

In this regard, one can choose other commercially available polymeric materials such as polypropylene (PP), as it has a lower Dk (~2.225) and Df (~0.0019) even at higher frequencies (e.g., at 47-75 GHz). The mechanical and thermal properties of neat polypropylene, however, are not sufficient enough to meet certain manufacturing process steps and operational conditions. Though incorporation of certain additives into polypropylene may improve its mechanical and thermal properties, the dielectric properties and metal adhesion characteristics of polypropylene may be impacted with these additives.

Accordingly, there is a need to modify polypropylene with those additives that provide a synergistic effect such that the modified polypropylene has low Dk and Df values, high metal adhesion strength, low CTE, and good mechanical and thermal properties such that it is suitable for higher frequency (>6 GHz) applications.

### SUMMARY

A polypropylene composition for use in high-frequency radio-wave applications of 6 GHz or greater comprises a mixture of a polypropylene, hollow glass bubbles having an average diameter or particle size of from 5 μm to 80 μm, and at least one or several additives. The additives may include glass fibers having a length of from 0.5 mm to 10 mm and a width or diameter of from 5 μm to 15 μm, aluminum oxide fibers having a length of from 1 mm to 5 mm and a width or diameter of from 1 μm to 30 μm, a cyclic olefin copolymer, and a polycarbonate.

In particular embodiments, the composition includes the hollow glass bubbles in an amount of from 1 wt % to 35 wt %. The hollow glass bubbles may have at least one of a crush strength of 30 MPa or more, a true density of from 0.3 g/cc to 0.8 g/cc, and a gas volume of from 50% to 90%.

The glass fibers may be present in an amount of 40 wt % or less by total weight of the composition. The glass fibers may have at least one of a dielectric constant (Dk) of 4 or greater, as measured according to ASTM D150 at 6 MHz or higher, a dissipation factor (Df) of 0.005 or less, as measured according to ASTM D150 at 6 MHz or higher, and a coefficient of thermal expansion (CTE) of 35×10-6/° C. or less, as measured according to ASTM D696.

The composition may further include the aluminum oxide fibers in an amount of 40 wt % or less by total weight of the composition.

The polypropylene may be a copolymer with comonomers selected from C₂ and C₄ to C₁₀ olefin monomers, with the comonomers being present in the copolymer in an amount of from 15 wt % or less.

A cyclic olefin copolymer may also be present in an amount of 20 wt % or less by total weight of the composition. If included, the polycarbonate may be present in an amount of 20 wt % or less by total weight of the composition. The composition may also include at least one of polyvinylcyclohexane and poly(1,4-cyclohexylidene cyclohexane-1,4-dicarboxylate).

Various other additives may also be included in the composition. These may include a stabilizing agent, a coupling agent, a compatibilizing agent, a heat conductive agent, a fire retardant additive, a thermally conductive additive, a tie agent, an antiblocking agent, an antistatic agent, an antioxidant, a neutralizing agent, an acid scavenger, a blowing agent, a nucleating agent, a crystallization aid, a dye, a flame retardant agent, a filler, a hard filler, a soft filler, an impact modifier, a mold release agent, an oil, another polymer, a pigment, a processing agent, a reinforcing agent, a light stabilizer, an UV resistance agent, a slip agent, a flow modifying agent, and combinations thereof.

The polypropylene composition may have a Dk value of 2.5 or less, when measured at 6 GHz or higher, and a Df value of 0.005 or less, when measured at 6 GHz or higher. The polypropylene composition may have one or more of a metal adhesion peel strength of 0.1 N/mm or greater, as measured according to ASTM B533 or IPC-TM-650; a coefficient of thermal expansion (CTE) of 60 ppm/° C. or less, as measured according to ASTM D696; a heat deflection temperature (HDT) of 100° C. or greater, as measured according to ASTM D648; water absorption of 0.05 wt % or less, as measured according to ASTM D570; a tensile modulus of 2000 MPa or more, as measured according to ASTM D638; a tensile strength of 35 MPa or more, as measured according to ASTM D638; a density of 1.4 g/cc or less; a UL94 flame retardancy rating of V0@1.5 mm; and a thermal conductivity of 0.2 W/mK or more, as measured according to ASTM C518.

The polypropylene composition can be formed into an article of manufacture. The article of manufacture may be a telecommunication device or component, a high frequency (>6 GHz) electrical device, a high frequency (>6 GHz) multi-generational telecommunication device or component, a 5G or higher generation telecommunication antenna and end-use device or component, a telecommunication device housing, a radome cover, a radio-frequency (RF) filter, an RF connector, an EMI shield, an antenna substrate, a waveguide substrate or carrier, an antenna substrate in a base station antenna, an automotive radar component.

In a method of forming a polypropylene composition for use in high-frequency radio-wave applications of 6 GHz or greater, a polypropylene is modified by melt blending the polypropylene with various materials. These include hollow glass bubbles having an average diameter or particle size of from 5 μm to 80 μm, and at least one of glass fibers having a length of from 0.5 mm to 10 mm and a width or diameter of from 5 μm to 15 μm, aluminum oxide fibers having a length of from 1 mm to 5 mm and a width or diameter of from 1 μm to 15 μm, a cyclic olefin copolymer, and a polycarbonate so that the materials are dispersed throughout the polypropylene.

In some embodiments of the present disclosure, a polypropylene composition for use in high-frequency radio-wave applications of 6 GHz or greater comprises: a mixture of (i) polypropylene, (ii) hollow glass bubbles having an average diameter or particle size of from 5 μm to 80 μm, (iii) at least one of glass fibers having a length of from 0.5 mm to 10 mm and a width or diameter of from 5 μm to 15 μm and aluminum oxide fibers having a length of from 1 mm to 5 mm and a width or diameter of from 1 μm to 30 μm; and (iv) at least one of a cyclic olefin copolymer and polycarbonate.

### DETAILED DESCRIPTION

Compared to those high-cost materials currently used for high-frequency radio wave applications, polypropylene (PP) is a readily available and relatively low-cost material. Polypropylene has yet to be widely used for high-frequency radio wave applications, however, due to neat polypropylene's inherent shortcomings at these higher frequencies. In the present invention, polypropylene is melt blended with a mixture of synergistic additives that overcome these shortcomings and make the polypropylene composition suitable for use in high-frequency radio-wave applications of 6 GHz or greater.

The modified polypropylene is tailored so that it is light-weight, has a low dielectric constant (Dk), a low dissipation factor (Df), high metal adhesion strength, low coefficient of thermal expansion (CTE), high mechanical strength, and good thermal performance. By using a blend of polypropylene with those particular additives described herein, these properties can be achieved.

The polypropylene component of the polymer blend may constitute homopolymers of propylene. The polypropylene is typically an isotactic polypropylene, such as those formed from Ziegler-Natta catalysts. The polypropylene is typically unimodal but may have a broad molecular weight distribution or polydispersity index (PDI) and range of melt flow index (MFI) values. An example of a suitable commercially available polypropylene homopolymer is that available as SABIC® PP571 polypropylene, available from Saudi Basic Industries Corporation, Riyadh, Saudi Arabia.

In other embodiments, the polypropylene component can include copolymers of non-propylene monomers, such as ethylene and/or at least one C₄ to C₁₀ alpha olefin. Typically, for non-ethylene comonomers this will be at least one of the alpha olefins of butene, hexene, and/or octene. When such copolymers are used, the non-propylene comonomer component may be present in the polypropylene copolymer in an amount of 15 wt % or less, with from 2 wt % to 15 wt % being used in many instances. In particular embodiments, the non-propylene comonomer component may be present in the polypropylene copolymer in an amount of from at least, equal to, and/or between any two of 0.1 wt %, 0.2 wt %, 0.3 wt %, 0.4 wt %, 0.5 wt %, 0.6 wt %, 0.7 wt %, 0.8 wt %, 0.9 wt %, 1.0 wt %, 1.1 wt %, 1.2 wt %, 1.3 wt %, 1.4 wt %, 1.5 wt %, 1.6 wt %, 1.7 wt %, 1.8 wt %, 1.9 wt %, 2.0 wt %, 2.1 wt %, 2.2 wt %, 2.3 wt %, 2.4 wt %, 2.5 wt %, 2.6 wt %, 2.7 wt %, 2.8 wt %, 2.9 wt %, 3.0 wt %, 3.1 wt %, 3.2 wt %, 3.3 wt %, 3.4 wt %, 3.5 wt %, 3.6 wt %, 3.7 wt %, 3.8 wt %, 3.9 wt %, 4.0 wt %, 4.1 wt %, 4.2 wt %, 4.3 wt %, 4.4 wt %, 4.5 wt %, 4.6 wt %, 4.7 wt %, 4.8 wt %, 4.9 wt %, 5.0 wt %, 5.1 wt %, 5.2 wt %, 5.3 wt %, 5.4 wt %, 5.5 wt %, 5.6 wt %, 5.7 wt %, 5.8 wt %, 5.9 wt %, 6.0 wt %, 6.1 wt %, 6.2 wt %, 6.3 wt %, 6.4 wt %, 6.5 wt %, 6.6 wt %, 6.7 wt %, 6.8 wt %, 6.9 wt %, 7.0 wt %, 7.1 wt %, 7.2 wt %, 7.3 wt %, 7.4 wt %, 7.5 wt %, 7.6 wt %, 7.7 wt %, 7.8 wt %, 7.9 wt %, 8.0 wt %, 8.1 wt %, 8.2 wt %, 8.3 wt %, 8.4 wt %, 8.5 wt %, 8.6 wt %, 8.7 wt %, 8.8 wt %, 8.9 wt %, 9.0 wt %, 9.1 wt %, 9.2 wt %, 9.3 wt %, 9.4 wt %, 9.5 wt %, 9.6 wt %, 9.7 wt %, 9.8 wt %, 9.9 wt %, 10.0 wt %, 10.1 wt %, 10.2 wt %, 10.3 wt %, 10.4 wt %, 10.5 wt %, 10.6 wt %, 10.7 wt %, 10.8 wt %, 10.9 wt %, 11.0 wt %, 11.1 wt %, 11.2 wt %, 11.3 wt %, 11.4 wt %, 11.5 wt %, 11.6 wt %, 11.7 wt %, 11.8 wt %, 11.9 wt %, 12.0 wt %, 12.1 wt %, 12.2 wt %, 12.3 wt %, 12.4 wt %, 12.5 wt %, 12.6 wt %, 12.7 wt %, 12.8 wt %, 12.9 wt %, 13.0 wt %, 13.1 wt %, 13.2 wt %, 13.3 wt %, 13.4 wt %, 13.5 wt %, 13.6 wt %, 13.7 wt %, 13.8 wt %, 13.9 wt %, 14.0 wt %, 14.1 wt %, 14.2 wt %, 14.3 wt %, 14.4 wt %, 14.5 wt %, 14.6 wt %, 14.7 wt %, 14.8 wt %, 14.9 wt %, and 15.0 wt %. In some embodiments, there is only ethylene comonomer in the polypropylene copolymer with no C₄ to C₁₀ alpha olefin comonomer.

It should be noted in the description, if a numerical value, concentration or range is presented, each numerical value should be read once as modified by the term “about” (unless already expressly so modified), and then read again as not so modified unless otherwise indicated in context. Also, in the description, it should be understood that an amount range listed or described as being useful, suitable, or the like, is intended that any and every value within the range, including the end points, is to be considered as having been stated. For example, “a range of from 1 to 10” is to be read as indicating each and every possible number along the continuum between about 1 and about 10. Thus, even if specific points within the range, or even no point within the range, are explicitly identified or referred to, it is to be understood that the inventor appreciates and understands that any and all points within the range are to be considered to have been specified, and that inventor possesses the entire range and all points within the range, including smaller ranges within the larger ranges.

As discussed throughout the following description, as it relates to the polypropylene component of the polypropylene composition, the expression “polypropylene” is meant to include both polypropylene homopolymers and polypropylene copolymers, unless expressly stated otherwise or is otherwise apparent from its context.

The polypropylene component of the composition can be characterized by various properties such as average molecular weight, density, melt flow index (MFI), polydispersity index (PDI), ESCR, tensile strength at yield, tensile modulus, tensile elongation at yield, Izod notched impact strength, hardness or combinations thereof.

The average molecular weight (Mw) of the polypropylene component is determined by high temperature gel permeation chromatography. In particular, the average molecular weight (Mw) of the polypropylene may be from at least, equal to, and/or between any two of 130,000, 140,000, 150,000, 160,000, 170,000, 180,000, 190,000, 200,000, 210,000, 220,000, 230,000, 240,000, 250,000, 260,000, 270,000, 280,000, 290,000, and 300,000 as determined by high temperature gel permeation chromatography. Unless otherwise specified, all average molecular weights (Mw) for those polymers described herein are those determined by high temperature gel permeation chromatography.

The density of the polypropylene can be from 0.900 g/cm³ or 0.920 g/cm³. In particular, the density of the polypropylene may be from at least, equal to, and/or between any two of 0.900 g/cm³, 0.901 g/cm³, 0.902 g/cm³, 0.903 g/cm³, 0.904 g/cm³, 0.905 g/cm³, 0.906 g/cm³, 0.907 g/cm³, 0.908 g/cm³, 0.909 g/cm³, 0.910 g/cm³, 0.911 g/cm³, 0.912 g/cm³, 0.913 g/cm³, 0.914 g/cm³, 0.915 g/cm³, 0.916 g/cm³, 0.917 g/cm³, 0.918 g/cm³, 0.919 g/cm³, and 0.920 g/cm³

The polypropylene can have an MFI at 230° C. and 2.16 kg loading of from 0.1 g/10 min to 70 g/10 min as per ISO 1133, or at least, equal to, and/or between any two of 0.1 g/10 min, 0.2 g/10 min, 0.3 g/10 min, 0.4 g/10 min, 0.5 g/10 min, 0.6 g/10 min, 0.7 g/10 min, 0.8 g/10 min, 0.9 g/10 min, 1.0 g/10 min, 1.1 g/10 min, 1.2 g/10 min, 1.3 g/10 min, 1.4 g/10 min, 1.5 g/10 min, 1.6 g/10 min, 1.7 g/10 min, 1.8 g/10 min, 1.9 g/10 min, 2.0 g/10 min, 2.1 g/10 min, 2.2 g/10 min, 2.3 g/10 min, 2.4 g/10 min, 2.5 g/10 min, 2.6 g/10 min, 2.7 g/10 min, 2.8 g/10 min, 2.9 g/10 min, 3.0 g/10 min, 3.1 g/10 min, 3.2 g/10 min, 3.3 g/10 min, 3.4 g/10 min, 3.5 g/10 min, 3.6 g/10 min, 3.7 g/10 min, 3.8 g/10 min, 3.9 g/10 min, 4.0 g/10 min, 4.1 g/10 min, 4.2 g/10 min, 4.3 g/10 min, 4.4 g/10 min, 4.5 g/10 min, 4.6 g/10 min, 4.7 g/10 min, 4.8 g/10 min, 4.9 g/10 min, 5.0 g/10 min, 5.1 g/10 min, 5.2 g/10 min, 5.3 g/10 min, 5.4 g/10 min, 5.5 g/10 min, 5.6 g/10 min, 5.7 g/10 min, 5.8 g/10 min, 5.9 g/10 min, 6.0 g/10 min, 6.1 g/10 min, 6.2 g/10 min, 6.3 g/10 min, 6.4 g/10 min, 6.5 g/10 min, 6.6 g/10 min, 6.7 g/10 min, 6.8 g/10 min, 6.9 g/10 min, 7.0 g/10 min, 7.1 g/10 min, 7.2 g/10 min, 7.3 g/10 min, 7.4 g/10 min, 7.5 g/10 min, 7.6 g/10 min, 7.7 g/10 min, 7.8 g/10 min, 7.9 g/10 min, 8.0 g/10 min, 8.1 g/10 min, 8.2 g/10 min, 8.3 g/10 min, 8.4 g/10 min, 8.5 g/10 min, 8.6 g/10 min, 8.7 g/10 min, 8.8 g/10 min, 8.9 g/10 min, 9.0 g/10 min, 9.1 g/10 min, 9.2 g/10 min, 9.3 g/10 min, 9.4 g/10 min, 9.5 g/10 min, 9.6 g/10 min, 9.7 g/10 min, 9.8 g/10 min, 9.9 g/10 min, 10.0 g/10 min, 11 g/10 min, 12 g/10 min, 13 g/10 min, 14 g/10 min, 15 g/10 min, 16 g/10 min, 17 g/10 min, 18 g/10 min, 19 g/10 min, 20 g/10 min, 21 g/10 min, 22 g/10 min, 23 g/10 min, 24 g/10 min, 25 g/10 min, 26 g/10 min, 27 g/10 min, 28 g/10 min, 29 g/10 min, 30 g/10 min, 31 g/10 min, 32 g/10 min, 33 g/10 min, 34 g/10 min, 35 g/10 min, 36 g/10 min, 37 g/10 min, 38 g/10 min, 39 g/10 min, 40 g/10 min, 41 g/10 min, 42 g/10 min, 43 g/10 min, 44 g/10 min, 45 g/10 min, 46 g/10 min, 47 g/10 min, 48 g/10 min, 49 g/10 min, 50 g/10 min, 51 g/10 min, 52 g/10 min, 53 g/10 min, 54 g/10 min, 55 g/10 min, 56 g/10 min, 57 g/10 min, 58 g/10 min, 59 g/10 min, 60 g/10 min, 61 g/10 min, 62 g/10 min, 63 g/10 min, 64 g/10 min, 65 g/10 min, 66 g/10 min, 67 g/10 min, 68 g/10 min, 69 g/10 min, and 70 g/10 min, as per ISO 1133.

In certain instances, the polypropylene may be that polypropylene that has been modified to improve is processibility, such as that prepared using peroxide shifting. Such polypropylene may have a higher MFI than that polypropylene that has not been so modified. In particular, the modified polypropylene, such as that prepared using peroxide shifting, may have a MFI at 230° C. and 2.16 kg loading of from 10 g/10 min or 20 g/10 min to 100 g/10 min, as per ISO 1133, or at least, equal to, and/or between any two of 10 g/10 min, 11 g/10 min, 12 g/10 min, 13 g/10 min, 14 g/10 min, 15 g/10 min, 16 g/10 min, 17 g/10 min, 18 g/10 min, 19 g/10 min, 20 g/10 min, 21 g/10 min, 22 g/10 min, 23 g/10 min, 24 g/10 min, 25 g/10 min, 26 g/10 min, 27 g/10 min, 28 g/10 min, 29 g/10 min, 30 g/10 min, 31 g/10 min, 32 g/10 min, 33 g/10 min, 34 g/10 min, 35 g/10 min, 36 g/10 min, 37 g/10 min, 38 g/10 min, 39 g/10 min, 40 g/10 min, 41 g/10 min, 42 g/10 min, 43 g/10 min, 44 g/10 min, 45 g/10 min, 46 g/10 min, 47 g/10 min, 48 g/10 min, 49 g/10 min, 50 g/10 min, 51 g/10 min, 52 g/10 min, 53 g/10 min, 54 g/10 min, 55 g/10 min, 56 g/10 min, 57 g/10 min, 58 g/10 min, 59 g/10 min, 60 g/10 min, 61 g/10 min, 62 g/10 min, 63 g/10 min, 64 g/10 min, 65 g/10 min, 66 g/10 min, 67 g/10 min, 68 g/10 min, 69 g/10 min, 70 g/10 min, 71 g/10 min, 72 g/10 min, 73 g/10 min, 74 g/10 min, 75 g/10 min, 76 g/10 min, 77 g/10 min, 78 g/10 min, 79 g/10 min, 80 g/10 min, 81 g/10 min, 82 g/10 min, 83 g/10 min, 84 g/10 min, 85 g/10 min, 86 g/10 min, 87 g/10 min, 88 g/10 min, 89 g/10 min, 90 g/10 min, 91 g/10 min, 92 g/10 min, 93 g/10 min, 94 g/10 min, 95 g/10 min, 96 g/10 min, 97 g/10 min, 98 g/10 min, 99 g/10 min, and 100 g/10 min, as per ISO 1133.

The polypropylene component may have a polydispersity index (PDI=Mw/Mn) of from 4 to 10, as determined by high temperature gel permeation chromatography, or at least, equal to, and/or between any two of 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, and 10.0.

Tensile modulus of the polypropylene can be from 800 MPa to 2200 MPa, or at least, equal to, and/or between any two of 800 MPa, 850 MPa, 900 MPa, 950 MPa, 1000 MPa, 1050 MPa, 1100 MPa, 1150 MPa, 1200 MPa, 1250 MPa, 1300 MPa, 1350 MPa, 1400 MPa, 1450 MPa, 1500 MPa, 1550 MPa, 1600 MPa, 1650 MPa, 1700 MPa, 1750 MPa, 1800 MPa, 1850 MPa, 1900 MPa, 1950 MPa, 2000 MPa, 2050 MPa, 2100 MPa, 2150 MPa, and 2200 MPa, as measured by ISO 527. Tensile strength at yield of the polypropylene can be from 20 MPa to 40 MPa, or at least, equal to, and/or between any two of 20 MPa, 25 MPa, 30 MPa, 35 MPa, and 40 MPa, as measured by ASTM D638.

The Izod notched impact strength of the polypropylene component at 23° C. can be from 10 J/m to 30 J/m or at least, equal to, and/or between any two of 10 J/m, 11 J/m, 12 J/m, 13 J/m, 14 J/m, 15 J/m, 16 J/m, 17 J/m, 18 J/m, 19 J/m, 20 J/m, 21 J/m, 22 J/m, 23 J/m, 24 J/m, 25 J/m, 26 J/m, 27 J/m, 28 J/m, 29 J/m, and 30 J/m, as measured by ASTM D256.

The polypropylene component, as described above, is used as a polymer blend in combination with one or more different primary additives for use in the high-frequency radio wave applications. These primary additives are those that may impart a lower Dk, a lower Df, higher metal adhesion strength, and a low CTE for the polypropylene composition as compared to the polypropylene without such additives. The polypropylene composition may also exhibit high mechanical strength and good thermal performance.

The primary additives include hollow glass bubbles. Such glass bubbles help reduce the bulk density of the polypropylene, as well as lower the Dk and Df values. This is due, at least in part, to the lower Dk and Df values of the glass bubbles themselves because of the presence of air, gas or vacuum space within the glass bubbles.

The glass bubbles are typically hollow, thin-walled unicellular spheres made from soda-lime borosilicate glass. The glass bubbles may have an average diameter or particle size of from 5 μm to 80 μm, more particularly an average diameter or particle size of from 15 μm to 65 μm. In particular embodiments, the glass bubbles may have an average diameter or particle size of at least, equal to, and/or between any two of 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, and 20 μm, 21 μm, 22 μm, 23 μm, 24 μm, 25 μm, 26 μm, 27 μm, 28 μm, 29 μm, 30 μm, 31 μm, 32 μm, 33 μm, 34 μm, 35 μm, 36 μm, 37 μm, 38 μm, 39 μm, 40 μm, 41 μm, 42 μm, 43 μm, 44 μm, 45 μm, 46 μm, 47 μm, 48 μm, 49 μm, 50 μm, 51 μm, 52 μm, 53 μm, 54 μm, 55 μm, 56 μm, 57 μm, 58 μm, 59 μm, 60 μm, 61 μm, 62 μm, 63 μm, 64 μm, 65 μm, 66 μm, 67 μm, 68 μm, 69 μm, 70 μm, 71 μm, 72 μm, 73 μm, 74 μm, 75 μm, 76 μm, 77 μm, 78 μm, 79 μm, and 80 μm.

The hollow glass bubbles may have a wall thickness of from 0.4 μm to 1.5 μm, more particularly from 0.5 μm to 0.9 μm, and still more particularly from 0.6 μm to 0.8 μm. In particular embodiments, the glass bubbles may have wall thickness of at least, equal to, and/or between any two of 0.40 μm, 0.41 μm, 0.42 μm, 0.43 μm, 0.44 μm, 0.45 μm, 0.46 μm, 0.47 μm, 0.48 μm, 0.49 μm, 0.50 μm, 0.51 μm, 0.52 μm, 0.53 μm, 0.54 μm, 0.55 μm, 0.56 μm, 0.57 μm, 0.58 μm, 0.59 μm, 0.60 μm, 0.61 μm, 0.62 μm, 0.63 μm, 0.64 μm, 0.65 μm, 0.66 μm, 0.67 μm, 0.68 μm, 0.69 μm, 0.70 μm, 0.71 μm, 0.72 μm, 0.73 μm, 0.74 μm, 0.75 μm, 0.76 μm, 0.77 μm, 0.78 μm, 0.79 μm, 0.80 μm, 0.81 μm, 0.82 μm, 0.83 μm, 0.84 μm, 0.85 μm, 0.86 μm, 0.87 μm, 0.88 μm, 0.89 μm, 0.90 μm, 0.91 μm, 0.92 μm, 0.93 μm, 0.94 μm, 0.95 μm, 0.96 μm, 0.97 μm, 0.98 μm, 0.99 μm, 1.00 μm, 1.11 μm, 1.12 μm, 1.13 μm, 1.14 μm, 1.15 μm, 1.16 μm, 1.17 μm, 1.18 μm, 1.19 μm, 1.20 μm, 1.21 μm, 1.22 μm, 1.23 μm, 1.24 μm, 1.25 μm, 1.26 μm, 1.27 μm, 1.28 μm, 1.29 μm, 1.30 μm, 1.31 μm, 1.32 μm, 1.33 μm, 1.34 μm, 1.35 μm, 1.36 μm, 1.37 μm, 1.38 μm, 1.39 μm, 1.40 μm, 1.41 μm, 1.42 μm, 1.43 μm, 1.44 μm, 1.45 μm, 1.46 μm, 1.47 μm, 1.48 μm, 1.49 μm, and 1.50 μm.

This may provide a gas volume or interior space within the hollow glass sphere of from 50% to approximately 90%. Those glass bubbles having a gas volume or interior space of from 60% to 80% have been found to be particularly useful. In particular embodiments, gas volume or interior space within the hollow glass bubble may be at least, equal to, and/or between any two of 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, and 90%. The interior space of the glass bubbles is typically filled with air, but may also be filled with other gases, such as nitrogen. The interior space may also be without any medium (vacuum) or filled with low dielectric liquids that facilitate lowering of the Dk and Df values.

The glass bubbles may have a true density of 0.3 g/cc to 0.8 g/cc, as measured by helium pycnometry. In particular embodiments, the glass bubbles may have a true density of at least, equal to, and/or between any two of 0.30 g/cc, 0.31 g/cc, 0.32 g/cc, 0.33 g/cc, 0.34 g/cc, 0.35 g/cc, 0.36 g/cc, 0.37 g/cc, 0.38 g/cc, 0.39 g/cc, 0 g/cc, 0.41 g/cc, 0.42 g/cc, 0.43 g/cc, 0.44 g/cc, 0.45 g/cc, 0.46 g/cc, 0.47 g/cc, 0.48 g/cc, 0.49 g/cc, 0.50 g/cc, 0.51 g/cc, 0.52 g/cc, 0.53 g/cc, 0.54 g/cc, 0.55 g/cc, 0.56 g/cc, 0.57 g/cc, 0.58 g/cc, 0.59 g/cc, 0.60 g/cc, 0.61 g/cc, 0.62 g/cc, 0.63 g/cc, 0.64 g/cc, 0.65 g/cc, 0.66 g/cc, 0.67 g/cc, 0.68 g/cc, 0.69 g/cc, 0.70 g/cc, 0.71 g/cc, 0.72 g/cc, 0.73 g/cc, 0.74 g/cc, 0.75 g/cc, 0.76 g/cc, 0.77 g/cc, 0.78 g/cc, 0.79 g/cc, 0.80 g/cc, as measured by helium pycnometry.

Furthermore, the hollow glass bubbles may have a crush strength of from 30 MPa to 300 MPa. In particular embodiments, the glass bubbles may have a crush strength of at least, equal to, and/or between any two of 30 MPa, 31 MPa, 32 MPa, 33 MPa, 34 MPa, 35 MPa, 36 MPa, 37 MPa, 38 MPa, 39 MPa, 40 MPa, 41 MPa, 42 MPa, 43 MPa, 44 MPa, 45 MPa, 46 MPa, 47 MPa, 48 MPa, 49 MPa, 50 MPa, 51 MPa, 52 MPa, 53 MPa, 54 MPa, 55 MPa, 56 MPa, 57 MPa, 58 MPa, 59 MPa, 65 MPa, 66 MPa, 67 MPa, 68 MPa, 69 MPa, 70 MPa, 71 MPa, 72 MPa, 73 MPa, 74 MPa, 75 MPa, 76 MPa, 77 MPa, 78 MPa, 79 MPa, 80 MPa, 81 MPa, 82 MPa, 83 MPa, 84 MPa, 85 MPa, 86 MPa, 87 MPa, 88 MPa, 89 MPa, 90 MPa, 91 MPa, 92 MPa, 93 MPa, 94 MPa, 95 MPa, 96 MPa, 97 MPa, 98 MPa, 99 MPa, 100 MPa, 105 MPa, 110 MPa, 115 MPa, 120 MPa, 125 MPa, 130 MPa, 135 MPa, 140 MPa, 145 MPa, 150 MPa, 155 MPa, 160 MPa, 165 MPa, 170 MPa, 175 MPa, 180 MPa, 185 MPa, 190 MPa, 195 MPa, 200 MPa, 205 MPa, 210 MPa, 215 MPa, 220 MPa, 225 MPa, 230 MPa, 235 MPa, 240 MPa, 245 MPa, 250 MPa, 255 MPa, 260 MPa, 265 MPa, 270 MPa, 275 MPa, 280 MPa, 285 MPa, 290 MPa, 295 MPa, and 300 MPa.

Examples of suitable commercially available hollow glass bubbles are those available as iM16K and iM30K glass bubbles, from 3M Company, Maplewood, Minnesota. Glass bubble (IM30K Hi-Strength Glass Bubbles) used in the present work is commercially procured from 3M™. The average diameter of glass bubble was measured by using Scanning Electron Microscopy (SEM). The crush strength and the gas volume of the hollow glass bubble were measured by 3M's internal QCM.

The hollow glass bubbles may be used in the polypropylene composition in an amount of from 1 wt % to 35 wt % by total weight of the polypropylene composition. In particular embodiments, the glass bubbles may be used in an amount of at least, equal to, and/or between any two of 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 29 wt %, 30 wt %, 31 wt %, 32 wt %, 33 wt %, 34 wt %, and 35 wt % by total weight of the polypropylene composition.

It may be expected that a certain amount of breakage of the glass bubbles will occur during the melt blending of the polymer composition. This may typically result in from 5% or less of the glass bubbles being broken. While breakage of the glass bubbles should be minimized, such broken glass bubbles essentially become glass powder, which can facilitate reinforcement of the polypropylene composition.

Because the glass bubbles and/or broken glass bubbles in themselves do not provide sufficient reinforcement of the polypropylene composition, other materials may also be used in the polypropylene composition. These include short glass fibers (SGF) materials, aluminum oxide fiber materials, cyclic olefin copolymers, and polycarbonate materials.

The glass fibers can be used to enhance both the mechanical and thermal properties of the polypropylene composition. This includes higher stiffness, higher tensile or flexural modulus, a lower CTE, a higher heat deflection temperature (HDT), and better dimensional stability, as compared to the polypropylene without such materials. The short glass fibers can also include those glass fibers having low Dk (i.e., from 4 to 5) and/or Df values (i.e., <0.005) so that the dielectric properties of the polymer composition with the glass bubbles are mostly remain unaffected. The glass fibers may also include amino-silane treated glass fibers to facilitate their dispersion in the polymer melt when used with maleic anhydride grafted polypropylene as a coupling agent.

The short glass fibers may have a length of from 0.5 mm to 10 mm and a width or diameter of from 5 μm to 15 μm. In particular applications, the short glass fibers may have a length of at least, equal to, and/or between any two of 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm, 3.0 mm, 3.1 mm, 3.2 mm, 3.3 mm, 3.4 mm, 3.5 mm, 3.6 mm, 3.7 mm, 3.8 mm, 3.9 mm, 4.0 mm, 4.1 mm, 4.2 mm, 4.3 mm, 4.4 mm, 4.5 mm, 4.6 mm, 4.7 mm, 4.8 mm, 4.9 mm, 5.0 mm, 5.1 mm, 5.2 mm, 5.3 mm, 5.4 mm, 5.5 mm, 5.6 mm, 5.7 mm, 5.8 mm, 5.9 mm, 6.0 mm, 6.1 mm, 6.2 mm, 6.3 mm, 6.4 mm, 6.5 mm, 6.6 mm, 6.7 mm, 6.8 mm, 6.9 mm, and 7.0 mm, 7.1 mm, 7.2 mm, 7.3 mm, 7.4 mm, 7.5 mm, 7.6 mm, 7.7 mm, 7.8 mm, 7.9 mm, 8.0 mm, 8.1 mm, 8.2 mm, 8.3 mm, 8.4 mm, 8.5 mm, 8.6 mm, 8.7 mm, 8.8 mm, 8.9 mm, 9.0 mm, 9.1 mm, 9.2 mm, 9.3 mm, 9.4 mm, 9.5 mm, 9.6 mm, 9.7 mm, 9.8 mm, 9.9 mm, and 10.0 mm. The short glass fibers may have a width or diameter of at least, equal to, and/or between any two of 5 μm, 6 μm, 7 μm, 8 μm, 9 μm, 10 μm, 11 μm, 12 μm, 13 μm, 14 μm, and 15 μm.

The short glass fibers may be used in the polypropylene composition in an amount of 40 wt % or less by total weight of the polypropylene composition, with from 1 wt % to 30 wt % by total weight of the polypropylene composition being suitable in many instances. In particular embodiments, the glass fibers may be used in an amount of at least, equal to, and/or between any two of 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 29 wt %, 30 wt %, 31 wt %, 32 wt %, 33 wt %, 34 wt %, 35 wt %, 36 wt %, 37 wt %, 38 wt %, 39 wt %, and 40 wt % by total weight of the polypropylene composition.

The polypropylene compositions incorporating the short glass fibers may have a CTE of 35×10⁻⁶/° C. or less, as measured according to ASTM D696. In certain embodiments, the CTE value of the polypropylene compositions incorporating the short glass fibers may be 35, 30, 25, 20, 15, 10, 9, 8, 7, 6, 5, 4, 3, 2, 1, or 0.5×10⁻⁶/° C. or less, as measured according to ASTM D696.

In certain applications, the short glass fibers may be those having higher or lower Dk and Df values, as both the low and high Dk and Df value glass fibers will offer similar reinforcing effects to the polypropylene composition. If used, the short glass fibers with higher Dk and Df values may be those having a Dk value of 5 or greater, as measured according to ASTM D150 at 6 MHz or higher, and a dissipation factor Dk of greater than 0.005, as measured according to ASTM D150 at 6 MHz or higher. Such glass fibers may include E-CR (E-Glass corrosion resistant) glass fibers. An example of such commercially available short glass fibers are those available as DS2200 13P glass fibers, from Braj Binani Group, Mumbai, India. These glass fibers are distinguished from those glass fibers having low Dk and Df values.

Glass fibers having low dielectric or Dk and Df values may also be used alone or in combination with those short glass fibers having higher Dk and Df values. The low Dk glass fibers may be those having a Dk value of from 4 to 5, as measured according to ASTM D150 at 6 MHz or higher. In certain embodiments, the low Dk glass fibers may have a Dk value of at least, equal to, and/or between any two of 4.0, 4.1, 4.2, 4.3, 4.4, 4.5, 4.6, 4.7, 4.8, 4.9, and 5.0. The low Df glass fibers may be those having a Df value of 0.005, 0.004, 0.003, 0.002, 0.001, 0.0009, 0.0008, 0.0007, 0.0006, 0.0005, 0.0004, 0.0003, 0.0002, 0.0001, or less. The low Dk and Df glass fibers may have one or both low Dk and low Df. Typically, the low Dk and Df fibers will have both low Dk and low Df. Such glass fibers may include HL-glass fibers. An example of such commercially available short glass fiber having low Dk and Df values are those available as CS(HL)303N-3 glass fibers, from Chongqing Polycomp International Corp, Chongqing, China.

The low Dk and low Df glass fibers may make up all or a portion of the total short glass fibers. The low Dk and low Df glass fibers may be present in the polypropylene composition in an amount of 40 wt % or less by total weight of the polypropylene composition. In particular embodiments, if used, the low Dk and low Df glass fibers may be used in an amount of at least, equal to, and/or between any two of 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 29 wt %, 30 wt %, 31 wt %, 32 wt %, 33 wt %, 34 wt %, 35 wt %, 36 wt %, 37 wt %, 38 wt %, 39 wt %, and 40 wt % by total weight of the polypropylene composition.

Aluminum oxide fibers may be used in the polypropylene composition. Aluminum oxide fibers enhance the mechanical properties, such as tensile modulus and stiffness, while remaining radio frequency (RF) transparent. The aluminum oxide fibers may be of any form of aluminum oxide phase and may be obtained using any suitable process. The aluminum oxide fibers can be of a generally cylindrical shape and/or of a flat shape. The length of the aluminum oxide fibers may be in the range of 1 mm to 10 mm length and the diameter or width may be in the range of 1 μm to 15 μm. In particular applications, the aluminum oxide fibers may have a length of at least, equal to, and/or between any two of 1.0 mm, 1.1 mm, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm, 3.0 mm, 3.1 mm, 3.2 mm, 3.3 mm, 3.4 mm, 3.5 mm, 3.6 mm, 3.7 mm, 3.8 mm, 3.9 mm, 4.0 mm, 4.1 mm, 4.2 mm, 4.3 mm, 4.4 mm, 4.5 mm, 4.6 mm, 4.7 mm, 4.8 mm, 4.9 mm, 5.0 mm, 5.1 mm, 5.2 mm, 5.3 mm, 5.4 mm, 5.5 mm, 5.6 mm, 5.7 mm, 5.8 mm, 5.9 mm, 6.0 mm, 6.1 mm, 6.2 mm, 6.3 mm, 6.4 mm, 6.5 mm, 6.6 mm, 6.7 mm, 6.8 mm, 6.9 mm, and 7.0 mm, 7.1 mm, 7.2 mm, 7.3 mm, 7.4 mm, 7.5 mm, 7.6 mm, 7.7 mm, 7.8 mm, 7.9 mm, 8.0 mm, 8.1 mm, 8.2 mm, 8.3 mm, 8.4 mm, 8.5 mm, 8.6 mm, 8.7 mm, 8.8 mm, 8.9 mm, 9.0 mm, 9.1 mm, 9.2 mm, 9.3 mm, 9.4 mm, 9.5 mm, 9.6 mm, 9.7 mm, 9.8 mm, 9.9 mm, and 10.0 mm. The aluminum oxide fibers may have a width or diameter of at least, equal to, and/or between any two of 1 μm, 2 μm, 3 μm, 4 μm, 5 μm, 6 μm, 7 μm, 8 μm, 9 μm, 10 μm, 11 μm, 12 μm, 13 μm, 14 μm, and 15 μm. An example of such commercially available aluminum oxide fibers are those available as Nextel 610 fibers, from 3M Company, Maplewood, Minnesota.

The aluminum oxide fibers may be present in the polypropylene composition in an amount of 40 wt % or less by total weight of the polypropylene composition. If used, in particular embodiments, the aluminum oxide fibers may be used in an amount of at least, equal to, and/or between any two of 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 29 wt %, 30 wt %, 31 wt %, 32 wt %, 33 wt %, 34 wt %, 35 wt %, 36 wt %, 37 wt %, 38 wt %, 39 wt %, and 40 wt % by total weight of the polypropylene composition.

Cyclic olefin copolymers may also be used in the polypropylene composition. Particularly useful are the olefin-norbornene copolymers, which contain comonomers such as 8,9,10-trinorborn-2-ene (norbornene) or 1,2,3,4,4a,5,8,8a-octahydro-1,4:5,8-dimethanonaphthalene (tetracyclododecene). Cyclic olefin copolymers have low Dk and Df values at frequencies of greater than 2 GHz. Their inclusion thus helps to provide lower Dk and Df values for the polypropylene composition. The cyclic olefin copolymers also help to reduce warpage and lower the CTE towards improving the heat performance of the polypropylene composition. Cyclic olefin copolymers are fully aliphatic polymers that are miscible and/or form co-continuous morphology when blended with polypropylene during extrusion. An example of a suitable cyclic olefin copolymer is that available as a TOPAS® 6017 Cyclic Olefin Copolymer, from TOPAS Advanced Polymers GmbH, Raunheim, Germany, which has heat distortion temperature (HDT) of 170° C.

Cyclic olefin copolymers may be used in an amount of 20 wt % or less by total weight of the polypropylene composition. If used, in particular embodiments, the cyclic olefin copolymers may be used in an amount of at least, equal to, and/or between any two of 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, and 20 wt % by total weight of the polypropylene composition.

Polycarbonate can also be used in the polypropylene composition. The weight average molecular weight of polycarbonates, as inferred by gel permeation chromatography, is in the range of 30,000 to 60,000, as per polystyrene standards. Polycarbonates are almost fully end-capped, as inferred from NMR analyses. Polycarbonates can improve the metal adhesion and lower the warpage. Such polycarbonates include, but are not limited to, bisphenol-A polycarbonate and copolycarbonates obtained with the varying proportions (e.g., 20% to 50%) of different comonomers. Particularly useful is bisphenol-A polycarbonate.

Polycarbonates may be used in an amount of 20 wt % or less by total weight of the polypropylene composition. If used, in particular embodiments, the polycarbonates may be used in an amount of at least, equal to, and/or between any two of 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, and 20 wt % by total weight of the polypropylene composition.

Polyvinylcyclohexane (PVCH) and poly(1,4-cyclohexylidene cyclohexane-1,4-dicarboxylate) (PCCD) may also be used in the polypropylene composition. PCCD may be obtained via the reaction of melt polycondensation of 1,4-cyclohexanedimethanol (CHDM) and 1,4-cyclohexanedicarboxylic acid (CHDA). PVCH may be obtained by polymerization of vinylcyclohexane or by catalytic reduction of polystyrene. These materials help to lower the warpage and lower the CTE and improve the heat performance. PVCH has a glass transition temperature of approximately 145° C. These materials are fully aliphatic polymers that are miscible and form co-continuous morphology when blended with polypropylene during extrusion.

The PVCH and PCCD may be used in an amount of 20 wt % or less by total weight of the polypropylene composition. If used, in particular embodiments, the PVCH and PCCD or their combination may be used in an amount of at least, equal to, and/or between any two of 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, and 20 wt % by total weight of the polypropylene composition

The polypropylene compositions or polymer blend formed during melt blending can further include at least one additional secondary additive, as distinguished from those primary additives discussed above. Such optional or secondary additives may be those that do not necessarily impact or increase the dielectric (i.e., Dk and Df values), mechanical or thermal properties of final product, although they may. These may be added to facilitate processing during the melt blending and extrusion process but may also impart various desired properties to the final polypropylene composition. Non-limiting examples of additional optional or secondary additives include stabilizing agent, a coupling agent, a compatibilizing agent, a heat conductive agent, a fire retardant additive, a thermally conductive additive, a tie agent, an antiblocking agent, an antistatic agent, an antioxidant, a neutralizing agent, an acid scavenger, a blowing agent, a nucleating agent, a crystallization aid, a dye, a flame retardant agent, a filler, a hard filler, a soft filler, an impact modifier, a mold release agent, an oil, another polymer, a pigment, a processing agent, a reinforcing agent, a light stabilizer, a UV resistance agent, a slip agent, a flow modifying agent, and combinations thereof, and combinations thereof.

A coupling agent may be incorporated in the polymer blend to achieve a good interface with glass fibers and the polypropylene component to enabling their uniform dispersion. The coupling agent may be a maleic anhydride grafted polypropylene (MA-g-PP). The coupling occurs in situ in the extruder. With the use of this coupling agent, the interaction between the maleic anhydride group and amino group on amino-silane treated glass fibers facilitates their dispersion. An example of a suitable coupling agent for polypropylene is that maleic anhydride grafted polypropylene (MA-g-PP), available as Exxelor™ PO 1020, from ExxonMobil. The coupling agent may be present in the polymer blend in amount of from 2 wt % or less by total weight of the polymer blend. In particular embodiments, if used, the coupling agent may be used in an amount of at least, equal to, and/or between any two of 0.01 wt %, 0.2 wt %, 0.3 wt %, 0.4 wt %, 0.5 wt %, 0.6 wt %, 0.7 wt %, 0.8 wt %, 0.9 wt %, 1.0 wt %, 1.1 wt %, 1.2 wt %, 1.3 wt %, 1.4 wt %, 1.5 wt %, 1.6 wt %, 1.7 wt %, 1.8 wt %, 1.9 wt %, and 2.0 wt % by total weight of the polymer blend.

In some instances, a heat conductive additive is present in the polymer blend in an amount of at least, equal to, and/or between any two of 0.01 wt %, 0.2 wt %, 0.3 wt %, 0.4 wt %, 0.5 wt %, 0.6 wt %, 0.7 wt %, 0.8 wt %, 0.9 wt %, and 1.0 wt % by total weight of the polymer blend. Non-limiting examples of heat conductive additive include, aluminum oxide, titanium dioxide, graphitic compounds, graphenes, boron nitride, aluminum nitride, zinc oxide.

In some embodiments, a filler is present in the polymer blend in amount of at least, equal to, and/or between any two of 0.01 wt %, 0.2 wt %, 0.3 wt %, 0.4 wt %, 0.5 wt %, 0.6 wt %, 0.7 wt %, 0.8 wt %, 0.9 wt %, 1.0 wt %, 2.0 wt %, 3.0 wt %, 4.0 wt %, 5.0 wt %, 6.0 wt %, 7.0 wt %, 8.0 wt %, 9.0 wt %, 10.0 wt %, 20.0 wt %, 30.0 wt % by total weight of the polymer blend. The filler can be a hard filler. Non-limiting examples of hard filler include inorganic particulate fillers such as talc, silica, calcium carbonate, inorganic layered fillers such as clays, mica. The filler can be a soft filler. Non-limiting examples of soft filler include immiscible particulate elastomeric/polymeric resins. The filler can also be a hollow filler. Non-limiting examples of hollow filler include, plastic microspheres, ceramic microspheres such as cenospheres made up of alumino silicate microspheres, metallic microspheres made up of aluminum and copper/silver microspheres, and phenolic microspheres.

In certain aspects, a light stabilizer is present in the polymer blend in an amount of at least, equal to, and/or between any two of 0.01 wt %, 0.2 wt %, 0.3 wt %, 0.4 wt %, 0.5 wt %, 0.6 wt %, 0.7 wt %, 0.8 wt %, 0.9 wt %, and 1.0 wt % by total weight of the polymer blend. The light stabilizer can be a hindered amine light stabilizer. The term “hindered amine light stabilizer” refers to a class of amine compounds having certain light stabilizing properties. Non-limiting examples, of hindered amine light stabilizers (HALS) include 1-cyclohexyloxy-2,2,6,6-tetramethyl-4-octadecylaminopiperidine; bis(2,2,6,6-tetramethylpiperidin-4-yl) sebacate; bis(1-acetoxy-2,2,6,6-tetramethylpiperidin-4-yl) sebacate; bis(1,2,2,6,6-pentamethylpiperidin-4-yl) sebacate; bis(1-cyclohexyloxy-2,2,6,6-tetramethylpiperidin-4-yl) sebacate; bis(1-octyloxy-2,2,6,6-tetramethylpiperidin-4-yl) sebacate; bis(1-acyl-2,2,6,6-tetramethylpiperidin-4-yl) sebacate; bis(1,2,2,6,6-pentamethyl-4-piperidyl) n-butyl-3,5-di-tert-butyl-4-hydroxybenzyl malonate; 2,4-bis[(1-cyclohexyloxy-2,2,6,6-tetramethylpiperidin-4-yl)butylamino]-6-(2-hydroxyethyl amino-s-triazine; bis(1-cyclohexyloxy-2,2,6,6-tetramethylpiperidin-4-yl) adipate; 2,4-bis[(1-cyclohexyloxy-2,2,6,6-piperidin-4-yl)butylamino]-6-chloro-s-triazine; 1-(2-hydroxy-2-methylpropoxy)-4-hydroxy-2,2,6,6-tetramethylpiperidine; 1-(2-hydroxy-2-methylpropoxy)-4-oxo-2,2,6,6-tetramethylpiperidine; 1-(2-hydroxy-2-methyl propoxy)-4-octadecanoyloxy-2,2,6,6-tetramethyl piperidine; bis(1-(2-hydroxy-2-methylpropoxy)-2,2,6,6-tetramethylpiperidin-4-yl) sebacate; bis(1-(2-hydroxy-2-methylpropoxy)-2,2,6,6-tetramethylpiperidin-4-yl) adipate; 2,4-bis {N-[1-(2-hydroxy-2-methyl propoxy)-2,2,6,6-tetramethylpiperidin-4-yl]-N-butylamino}-6-(2-hydroxyethylamino)-s-triazine; 4-benzoyl-2,2,6,6-tetramethylpiperidine; di-(1,2,2,6,6-pentamethylpiperidin-4-yl) p-methoxybenzylidenemalonate; 2,2,6,6-tetramethylpiperidin-4-yl octadecanoate; bis(1-octyloxy-2,2,6,6-tetramethylpiperidyl) succinate; 1,2,2,6,6-pentamethyl-4-aminopiperidine; 2-undecyl-7,7,9,9-tetramethyl-1-oxa-3,8-diaza-4-oxo-spiro[4,5]decane; tris(2,2,6,6-tetramethyl-4-piperidyl) nitrilotriacetate; tris(2-hydroxy-3-(amino-(2,2,6,6-tetramethylpiperidin-4-yl) propyl) nitrilotriacetate; tetrakis(2,2,6,6-tetramethyl-4-piperidyl)-1,2,3,4-butane-tetracarboxylate; tetrakis(1,2,2,6,6-pentamethyl-4-piperidyl)-1,2,3,4-butane-tetracarboxylate; 1,1′-(1,2-ethanediyl)-bis(3,3,5,5-tetramethylpiperazinone); 3-n-octyl-7,7,9,9-tetramethyl-1,3,8-triazaspiro[4.5]decan-2,4-dione; 8-acetyl-3-dodecyl-7,7,9,9-tetramethyl-1,3,8-triazaspiro[4.5]decane-2,4-dione; 3-dodecyl-1-(2,2,6,6-tetramethyl-4-piperidyl) pyrrolidin-2,5-dione; 3-dodecyl-1-(1,2,2,6,6-pentamethyl-4-piperidyl) pyrrolidine-2,5-dione; N,N′-bis-formyl-N,N′-bis(2,2,6,6-tetramethyl-4-piperidyl) hexamethylenediamine; reaction product of 2,4-bis[(1-cyclohexyloxy-2,2,6,6-piperidin-4-yl)butylamino]-6-chloro-s-triazine with N,N′-bis(3-aminopropyl)ethylenediamine); condensate of 1-(2-hydroxyethyl)-2,2,6,6-tetramethyl-4-hydroxypiperidine and succinic acid; condensate of N,N′-bis(2,2,6,6-tetramethyl-4-piperidyl)-hexamethylenediamine and 4-tert-octylamino-2,6-dichloro-1,3,5-triazine; condensate of N,N′-bis(2,2,6,6-tetramethyl-4-piperidyl)-hexamethylenediamine and 4-cyclohexylamino-2,6-dichloro-1,3,5-triazine; condensate of N,N′-bis-(2,2,6,6-tetramethyl-4-piperidyl) hexamethylenediamine and 4-morpholino-2,6-dichloro-1,3,5-triazine; condensate of N,N′-bis-(1,2,2,6,6-pentamethyl-4-piperidyl) hexamethylenediamine and 4-morpholino-2,6-dichloro-1,3,5-triazine; condensate of 2-chloro-4,6-bis(4-n-butylamino-2,2,6,6-tetramethyl piperidyl)-1,3,5-triazine and 1,2-bis(3-aminopropylamino) ethane; condensate of 2-chloro-4,6-di-(4-n-butylamino-1,2,2,6,6-pentamethylpiperidyl)-1,3,5-triazine and 1,2-bis-(3-aminopropylamino) ethane; a reaction product of 7,7,9,9-tetramethyl-2-cycloundecyl-1-oxa-3,8-diaza-4-oxospiro[4,5]decane and epichlorohydrin; poly[methyl, (3-oxy-(2,2,6,6-tetramethylpiperidin-4-yl) propyl)]siloxane, CAS #182635-99-0; reaction product of maleic acid anhydride-C18-C22-α-olefin-copolymer with 2,2,6,6-tetramethyl-4-aminopiperidine; oligomeric condensate of 4,4′-hexamethylenebis(amino-2,2,6,6-tetramethylpiperidine) and 2,4-dichloro-6-[(2,2,6,6-tetramethylpiperidin-4-yl)butylamino]-s-triazine end-capped with 2-chloro-4,6-bis(dibutylamino)-s-triazine; oligomeric condensate of 4,4′-hexamethylenebis(amino-1,2,2,6,6-pentaamethylpiperidine) and 2,4-dichloro-6-[(1,2,2,6,6-pentaamethylpiperidin-4-yl)butylamino]-s-triazine end-capped with 2-chloro-4,6-bis(dibutylamino)-s-triazine; oligomeric condensate of 4,4′-hexamethylenebis(amino-1-propoxy-2,2,6,6-tetramethyl piperidine) and 2,4-dichloro-6-[(1-propoxy-2,2,6,6-tetramethylpiperidin-4-yl)butylamino]-s-triazine end-capped with 2-chloro-4,6-bis(dibutylamino)-s-triazine; oligomeric condensate of 4,4′-hexamethylenebis(amino-1-acyloxy-2,2,6,6-tetramethyl piperidine) and 2,4-dichloro-6-[(1-acyloxy-2,2,6,6-tetramethylpiperidin-4-yl)butylamino]-s-triazine end-capped with 2-chloro-4,6-bis(dibutylamino)-s-triazine; and product obtained by reacting (a) with (b) where (a) is product obtained by reacting 1,2-bis(3-aminopropylamino) ethane with cyanuric chloride and (b) is (2,2,6,6-tetramethyl piperidin-4-yl)butylamine. Also included are the sterically hindered N—H, N-methyl, N-methoxy, N-hydroxy, N-propoxy, N-octyloxy, N-cyclohexyloxy, N-acyloxy and N-(2-hydroxy-2-methylpropoxy) analogues of any of the above-mentioned compounds. Non-limiting examples of commercial light stabilizer are available from BASF under the trade name Uvinul® 4050H, 4077H, 4092H, 5062H, 5050H, 4092H, 4077H, 3026, 3027, 3028, 3029, 3033P, and 3034 or Tinuvin® 622.

Anti-static agents can be used to inhibit accumulation of dust on plastic articles. Antistatic agents can improve the electrical conductivity of the plastic compositions, and thus dissipate any surface charges, which develop during production and use. Thus, dust particles are less attracted to the surface of the plastic article, and dust accumulation is consequently reduced. In certain aspects of the present invention, the antistatic agent can be a glycerol monostearate. The polymer blend can include an anti-static agent in an amount of at least, equal to, and/or between any two 0.01 wt %, 0.2 wt %, 0.3 wt %, 0.4 wt %, 0.5 wt %, 0.6 wt %, 0.7 wt %, 0.8 wt %, 0.9 wt %, and 1 wt % by total weight of the polymer blend.

A lubricant can be added to a polymer blend to improve the mold-making characteristics. The lubricant can be a low molecular compound from a group of fatty acids, fatty acid esters, wax ester, fatty alcohol ester, amide waxes, metal carboxylate, montanic acids, montanic acid ester, or such high molecular compounds, as paraffins or polyethylene waxes. In certain aspects of the present invention, the lubricant is a metal stearate. Non-limiting examples of metal stearates include zinc stearate, calcium stearate, lithium stearate or a combination thereof, preferably calcium stearate. The polymer blend can include a lubricant in an amount of at least, equal to, and/or between any two of 0.01 wt %, 0.2 wt %, 0.3 wt %, 0.4 wt %, 0.5 wt %, 0.6 wt %, 0.7 wt %, 0.8 wt %, 0.9 wt %, and 1 wt % by total weight of the polymer blend.

An antioxidant and/or heat stabilizer can provide protection against polymer degradation during processing. Phosphites are known thermal oxidative stabilizing agents for polymers and other organic materials. The antioxidant can be a phosphite-based antioxidant. In certain aspects phosphite-antioxidants include, but are not limited to, triphenyl phosphite, diphenylalkyl phosphites, phenyldialkyl phosphites, tris(nonylphenyl) phosphite, trilauryl phosphite, trioctadecyl phosphite, distearyl pentaerythritol diphosphite, tris(2,4-di-tertbutylphenyl) phosphite, diisodecyl pentaerythritol diphosphite, bis(2,4-di-tertbutylphenyl) pentaerythritol diphosphite tristearyl sorbitol triphosphite, and tetrakis(2,4-di-tertbutylphenyl)-4,4′-biphenylene diphosphonite, bis(2,4-dicumylphenyl) pentaerythritol diphosphite. The polymer blend can include an antioxidant in an amount of at least, equal to, and/or between any two of 0.01 wt %, 02 wt %, 0.3 wt %, 0.4 wt %, 0.5 wt %, 0.6 wt %, 0.7 wt %, 0.8 wt %, 0.9 wt %, and 0.1 wt % by total weight of the polymer blend. Non-limiting examples of commercially available antioxidants or heat stabilizers include Irganox 1010 and Irgaphos-168, both available from BASF, or Doverphos S9228T available from Dover Chemical Company.

Nucleating agents may also be used in the polymer blend. Nucleating agents may be considered as those additives that are added to polymers to facilitate crystal growth in the polymer melt. One or more nucleating agents may be used. Such nucleating agents may include, but are not limited, to cyclic dicarboxylate salts and talc. Talc is often used as a filler when used in higher amounts. When used in lower amounts (i.e., <5 wt %) talc acts as a nucleating agent. The use of the combination of a first nucleating agent of a cyclic dicarboxylate salt and a second nucleating agent of talc has been described in U.S. Pat. No. 11,136,446, which is herein incorporated by reference for all purposes. When such combination is used, the nucleating agents may be use in varying amounts. For example the weight ratio of the cyclic dicarboxylate salt to talc may range from 1:1200 to 2:1. The cyclic dicarboxylate salt may be used in an amount of from 0.0025 wt % to 0.1 wt % by total weight of the composition, with the talc nucleating agent being used in an amount of from 0.1 wt % to 5 wt %. An example of a suitable commercially available potassium salt of 1.2-cyclohexanedicarboxylic acid useful as a nucleating agent is that available as HYPERFORM® HPN 20E, from Milliken and Company.

In forming the polypropylene composition, the various components of the polypropylene composition, including the primary additives, as described, along with any additional optional secondary additives, can be dry blended. The polypropylene component may be in the form of pellets, powder, flakes or fluff. The materials are combined in a customary mixing machine, in which the polypropylene and primary additives are mixed with any optional additional or secondary additives. The optional secondary additives can be added at the end or during the processing steps to produce the polymer blend. Suitable machines for such mixing are known to those skilled in the art. Non-limiting examples include mixers, kneaders and extruders. These materials are then fed directly into the feed zone of an extruder. In certain cases, the process can be carried out in an extruder and introduction of the additives may occur during processing. Non-limiting examples of suitable extruders include single-screw extruders, counter-rotating and co-rotating twin-screw extruders, planetary-gear extruders, ring extruders, or co-kneaders. The process can be performed at a temperature from 180° C. to 300° C.

In some embodiments, the polypropylene component, primary additives, and any optional secondary additives, used to produce the polypropylene polymer blend of the present invention can be melt-extruded by following typical procedures of weighing the required amounts of the polypropylene and additives, followed by dry blending, and then feeding the mixture into a main feeder of a single-screw or twin-screw co-rotating extruder (length/diameter (L/D) ratio of 25:1 or 40:1) to obtain the final composition. The polypropylene, additives, or blend thereof can be subjected to an elevated temperature for a sufficient period of time during blending. The blending temperature can be above the melting point of the polymers. In certain aspects, the extrusion process can be performed at a temperature from 180° C. to 300° C. The primary and secondary additives can be in-line and prior to pelletization of the polypropylene resin during the production process. The amounts of additives combined with the polypropylene can be adjusted to provide those weight amounts previously discussed.

The optional secondary additives can be premixed or added individually to the polymer blend or the different components thereof. By way of example, the secondary additives of the present invention can be premixed such that the blend is formed prior to adding it to the polypropylene or the primary additives. The blend thereof can be subjected to an elevated temperature for a sufficient period of time during blending and/or incorporation of additives. Incorporation of optional secondary additives into the polymer resin can be carried out, for example, by mixing the above-described components using methods customary in process technology. The blending temperature can be above the melting point of the polypropylene polymers. In certain aspects, a process can be performed at a temperature from 180° C. to 260° C. Such “melt mixing” or “melt compounding” results in uniform dispersion of the present optional additives in the polypropylene and/or primary additives.

Articles that are manufactured from the polypropylene composition prepared as described can be used in high-frequency radio-wave applications of 6 GHz or greater. In particular, the polypropylene and/or articles formed therefrom may have a Dk value of 2.5, 2.4, 2.3, 2.2, 2.1, or 2.0 or less when measured at 6 GHz or higher. The polypropylene and/or articles formed therefrom may also have a Df value of 0.005, 0.004, 0.003, 0.002, 0.001, 0.0005 or less, when measured at 6 GHz or higher.

Additionally, the polypropylene composition and/or articles formed therefrom may have a metal adhesion peel strength of 0.1 N/mm, 0.2 N/mm, 0.3 N/mm, 0.4 N/mm, 0.5 N/mm, 0.6 N/mm, 0.7 N/mm, 0.8 N/mm, 0.9 N/mm, 1.0 N/mm or greater, as measured according to ASTM B533 or IPC-TM-650. In certain embodiments, the metal adhesion peel strength may range from at least, equal to, and/or between any two of 0.1 N/mm, 0.2 N/mm, 0.3 N/mm, 0.4 N/mm, 0.5 N/mm, 0.6 N/mm, 0.7 N/mm, 0.8 N/mm, 0.9 N/mm, 1.0 N/mm, 1.1 N/mm, 1.2 N/mm, 1.3 N/mm, 1.4 N/mm, and 1.5 N/mm, as measured according to ASTM B533 or IPC-TM-650.

The polypropylene composition or articles formed therefrom may have a CTE of 35 ppm/° C., 30 ppm/° C., 25 ppm/° C., 20 ppm/° C., 15 ppm/° C., 10 ppm/° C. or less, as measured according to ASTM D696. Furthermore, the polypropylene composition and/or articles formed therefrom may have a HDT of 110° C., 120° C., 130° C. 140° C., 150° C. or greater, as measured according to ASTM D648.

The polypropylene composition or article may also have a water absorption of 0.05 wt %, 0.04 wt %, 0.03 wt %, 0.02 wt %, 0.01 wt % or less by total weight, as measured according to ASTM D570. The composition or articles may also have a tensile modulus of 2000 MPa, 2100 MPa, 2200 MPa, 2300 MPa, 2400 MPa, 2500 MPa or more, as measured according to ASTM D638, and a tensile strength of 35 MPa, 40 MPa, 45 MPa, 50 MPa, 55 MPa, 60 MPa or more, as measured according to ASTM D638.

The polypropylene composition may have a density of 1.4 g/cc, 1.3 g/cc, 1.2 g/cc, 1.1 g/cc, 1.0 g/cc, 0.9 g/cc or less. It may also have a UL94 flame retardancy rating of V0@1.5 mm and a thermal conductivity of 0.10 W/mK, 0.15 W/mK, 0.20 W/mK, 0.25 W/mK, 0.30 W/mK, 0.35 W/mK, 0.40 W/mK, 0.45 W/mK, 0.5 W/mK or less, as measured according to ASTM C518.

The polypropylene composition may be useful for those particular applications at operating temperatures of −40° C. to 125° C. or higher.

The polypropylene compositions formed as described are normally collected as pellets, which can be stored for a time or employed immediately in a forming process. The forming processes can include injection molding, blow molding, compression molding, sheet extrusion, film blowing, pipe extrusion, profile extrusion, calendaring, thermoforming, rotomolding, or combinations thereof. The final formed polypropylene articles can be those used in high-frequency radio-wave applications of 6 GHz or greater. These may include, for instance, a telecommunication device or component, a high frequency (>6 GHz) electrical device, a high frequency (>6 GHz) multi-generational telecommunication device or component, a 5G or higher generation telecommunication antenna and end-use device or component, a telecommunication device housing, a radome cover, a radio-frequency (RF) filter, an RF connector, an EMI shield, an antenna substrate, a waveguide substrate or carrier, an antenna substrate in a base station antenna, and an automotive radar component.

The following examples serve to further illustrate various embodiments and applications.

### EXAMPLES

### Example 1

Polypropylene was modified by combining glass bubbles and various different additives to provide a polypropylene composition suitable for use in high-frequency radio-wave applications of 6 GHz or greater. The polypropylene compositions were prepared using SABIC® PP571 polypropylene, which is an isotactic polypropylene homopolymer having the following properties presented in Table 1 below:

TABLE 1

| Property | Typical Value | | Test Method |
|---|---|---|---|
| Melt Flow Rate | 5.7 | dg/min | ISO 1133 |
| 230° C. and 2.16 kg | | | |
| Density | 905 | kg/m³ | ASTM D1505 |
| Tensile Strength at Yield | 37 | MPa | ISO 527-2 1A |
| Tensile Strain at at Yield | 8% | | ISO 527-2 1A |
| Notched Izod Impact Strength | 4.0 | kJ/m² | ISO 179/1eA |
| at 23° C. | | | |
| Hardness, Shore D | 69 | | ISO 868 |
| Vicat Softening Point at 10N | 154° | C. | ISO 306 |
| Heat Deflection Temperature at | 85° | C. | ISO 75 |
| 455 kPa | | | |

Different additives for improving the dielectric, mechanical and thermal properties were used with the PP571 polypropylene. The hollow glass bubbles used were those available as iM30K glass bubbles formed from soda-lime-borosilicate glass having an average diameter of 18 μm, a true density of 0.60 g/cc, and a crush strength of 18.6 MPa. The low dielectric glass fibers (Low Dk-Df) were those available as CS(HL)303N-3 glass fibers having an average length of 3 mm, an average diameter of 13 μm, a Dk value of from 4.2 to 4.8, and a Df value of <0.001. The polycarbonate (PC) was bisphenol-A polycarbonate. The coupling agent was MA-g-PP.

For comparison purpose, neat PP571 polypropylene without any additives was also extruded and tested. The melt blending of different mixtures were carried out using a Coperion ZSK-25 mm twin screw extruder with a L/D ratio of 40:1 and fitted with 10 barrels and co-rotating screws. The temperature profile used during the extrusion is set forth in Table 2 below.

TABLE 2

| Barrel No | 1 | 2 | 3 | 4 | 5 | 6 | 7 | 8 | 9 | 10 |
|---|---|---|---|---|---|---|---|---|---|---|
| Temp. (° C.) | 120 | 180 | 200 | 220 | 230 | 230 | 240 | 240 | 240 | 250 |

Tables 3 and 4 below depict the details of formulations of both control and working examples (WE) and the mechanical, heat and dielectric characteristics of these formulations, respectively.

TABLE 3

| Working Examples | | | | | | |
|---|---|---|---|---|---|---|
| (WE) | Control | WE-1 | WE-2 | WE-3 | WE-4 | WE-5 |
| PP571 | 98 | 78 | 78 | 68 | 58 | 58 |
| PP571-side feeder | 0 | 10 | 0 | 0 | 0 | 0 |
| IM30K | | 10 | | | 10 | 10 |
| PC | | | | 10 | 10 | |
| Low DkGF | | | 20 | 20 | 20 | 20 |
| Irganox 1010 | 0.1 | 0.1 | 0.1 | 0.1 | 0.1 | 0.1 |
| Irgaphos-168 | 0.1 | 0.1 | 0.1 | 0.1 | 0.1 | 0.1 |
| Coupling agent | 1.6 | 1.6 | 1.6 | 1.6 | 1.6 | 1.6 |
| Talc | 0.2 | 0.2 | 0.2 | 0.2 | 0.2 | 0.2 |
| Total | 100 | 100 | 100 | 100 | 100 | 100 |

TABLE 4

| | Tensile | Tensile | Impact | HDT | CTE | dK | |
|---|---|---|---|---|---|---|---|
| | modulus | Strength | strength | (Std | [μm/(m · ° C.)] | (Std | |
| | MPa | MPa | KJ/m² | Dev) | −30 to +80° C. | Dev) | df |
| Control | 1830 (30.8) | 37.4 (1.2) | 3.4 (1.1) | 59.25 (1.1) | 94 | 2.208 | 0.00275 |
| | | | | | | (0.001) | (0.00028) |
| WE-1 | 2225 (55.4) | 27.0 (4.5) | 3.1 (1.2) | 63.9 (1.7) | 85.8 | 2.159 | 0.00408 |
| | | | | | | (0.017) | (0.00056) |
| WE-2 | 4812 (102.1) | 85.3 (3.2) | 14.8 (1.4) | 144.45 (0.8) | 40.1 | 2.401 | 0.00472 |
| | | | | | | (0.008) | (0.00080) |
| WE-3 | 4824 (113) | 81.0 (0.6) | 14.6 (3.7) | 138.7 (1.3) | 47.4 | 2.434 | 0.00472 |
| | | | | | | (0.008) | (0.00165) |
| WE-4 | 5492 (142.4) | 69.6 (0.31) | 12.5 (2.0) | 137.15 (1.2) | 35 | 2.403 | 0.00757 |
| | | | | | | (0.008) | (0.00096) |
| WE-5 | 5398 (131.3) | 71.4 (0.3) | 13.1 (2.) | 144.4 (1.1) | 34.9 | 2.459 | 0.00633 |
| | | | | | | (0.045) | (0.00193) |

Comparing properties of working example WE-1, incorporated with 10 wt % of glass bubbles, with those of the Control, without any performance improving additive, the incorporation of 10 wt % of glass bubbles increased the tensile modulus by ~20%, apart from a ~9% decrease of CTE, while maintaining other properties mostly intact. A relatively larger reinforcing effect as well as a large influence on heat and thermal properties is evident with the incorporation of low Dk glass fiber in working example WE-2. While mechanical properties such tensile modulus, tensile strength and impact strength are increased by ~163%, 130% and 335% on average, the heat deflection temperature (HDT) increased by ~150%. A significant lowering of CTE (by ~135%) was also evident with the incorporation low Dk glass fibers, while dielectric properties (Dk and Df) mostly remained unaffected. Though Dk and Df values of polypropylene increased slightly with the incorporation of low Dk glass fibers, a much higher increase of Dk and Df values were observed with the incorporation of similar loading of conventional short glass fibers, as reinforcing fillers. A still better reinforcement (as evident from increased modulus values) as well as a slight reduction of CTE is evident when both glass bubbles and low Dk glass fibers were used in combination, (compare working example WE-5 and Control). The incorporation of PC did not significantly affect the properties of the polypropylene compositions with low Dk glass fibers (compare working example WE-2 and working example WE-3), as well the polypropylene compositions with both low Dk glass fibers and glass bubbles (compare working example WE-2 and working example WE-4). The compositions exhibited an improved metal adhesion from preliminary metal plating experiments.

While the invention has been shown in some of its forms, it should be apparent to those skilled in the art that it is not so limited but is susceptible to various changes and modifications without departing from the scope of the invention based on experimental data or other optimizations considering the overall economics of the process. Accordingly, it is appropriate that the appended claims be construed broadly and, in a manner, consistent with the scope of the invention.

1. A polypropylene composition for use in high-frequency radio-wave applications of 6 GHz or greater, the composition comprising a mixture of a polypropylene, hollow glass bubbles having an average diameter of from 5 μm to 80 μm, and at least one of glass fibers having a length of from 0.5 mm to 10 mm and a width or diameter of from 5 μm to 15 μm, aluminum oxide fibers having a length of from 1 mm to 5 mm and a width or diameter of from 1 μm to 30 μm, a cyclic olefin copolymer, and a polycarbonate.

2. The composition of claim 1, wherein:
the composition includes the hollow glass bubbles in an amount of from 1 wt % to 35 wt %.

3. The composition of claim 2, wherein:
the hollow glass bubbles have at least one of a crush strength of 30 MPa or more as measured by QCM;
a true density of from 0.3 g/cc to 0.8 g/cc as measured by helium pycnometry; and
a gas volume of from 50% to 90% as measured by QCM.

4. The composition of claim 3, wherein:
the composition includes the glass fibers in an amount of 40 wt % or less by total weight of the composition.

5. The composition of claim 4, wherein:
the glass fibers have at least one of a dielectric constant (Dk) of 4 or greater, as measured according to ASTM D150 at 6 MHz or higher.

6. The composition of claim 5, wherein:
the composition includes the aluminum oxide fibers in an amount of 40 wt % or less by total weight of the composition.

7. The composition of claim 6, wherein:
the polypropylene is a copolymer with comonomers selected from C2 and C4 to C10 olefin monomers, the comonomers being present in the copolymer in an amount of from 15 wt % or less.

8. The composition of claim 7, wherein:
the composition includes the cyclic olefin copolymer in an amount of 20 wt % or less by total weight of the composition.

9. The composition of claim 8, wherein:
the composition includes the polycarbonate in an amount of 20 wt % or less by total weight of the composition.

10. The composition of claim 9, further comprising:
at least one of polyvinylcyclohexane and poly(1,4-cyclohexylidene cyclohexane-1,4-dicarboxylate).

11. The composition of claim 10, further comprising:
at least one of a stabilizing agent, a coupling agent, a compatibilizing agent, a heat conductive agent, a fire retardant additive, a thermally conductive additive, a tie agent, an antiblocking agent, an antistatic agent, an antioxidant, a neutralizing agent, an acid scavenger, a blowing agent, a nucleating agent, a crystallization aid, a dye, a flame retardant agent, a filler, a hard filler, a soft filler, an impact modifier, a mold release agent, an oil, another polymer, a pigment, a processing agent, a reinforcing agent, a light stabilizer, an UV resistance agent, a slip agent, a flow modifying agent, and combinations thereof.

12. The composition of claim 1, wherein:
the polypropylene composition has a Dk value of 2.5 or less, when measured at 6 GHz or higher, and a Df value of 0.005 or less, when measured at 6 GHz or higher, and at least one of the following:
a metal adhesion peel strength of 0.1 N/mm or greater, as measured according to ASTM B533 or IPC-TM-650,
a coefficient of thermal expansion (CTE) of 60 ppm/° C. or less, as measured according to ASTM D696;
a heat deflection temperature (HDT) of 100° C. or greater, as measured according to ASTM D648;
water absorption of 0.05 wt % or less, as measured according to ASTM D570;
a tensile modulus of 2000 MPa or more, as measured according to ASTM D638;
a tensile strength of 35 MPa or more, as measured according to ASTM D638;
a density of 1.4 g/cc or less;
a UL94 flame retardance rating of V0@1.5 mm; and
a thermal conductivity of 0.2 W/mK or greater, as measured according to ASTM C518.

13. (canceled)

14. (canceled)

15. A method of forming a polypropylene composition for use in high-frequency radio-wave applications of 6 GHz or greater, the method comprising modifying a polypropylene by melt blending the polypropylene with materials of hollow glass bubbles having an average diameter or particle size of from 5 μm to 80 μm, and at least one of glass fibers having a length of from 0.5 mm to 10 mm and a width or diameter of from 5 μm to 15 μm, aluminum oxide fibers having a length of from 1 mm to 5 mm and a width or diameter of from 1 μm to 15 μm, a cyclic olefin copolymer, and a polycarbonate.

16. The composition of claim 5, wherein the glass fibers have a dissipation factor (Df) of 0.005 or less, as measured according to ASTM D150 at 6 MHz or higher.

17. The composition of claim 4, wherein the glass fibers have a coefficient of thermal expansion (CTE) of 35×10-6/° C. or less, as measured according to ASTM D696.

18. The method of claim 15, wherein the method is performed at a temperature 180° C. to 260° C.

19. The method of claim 15, wherein the composition includes the polycarbonate in an amount of 20 wt % or less by total weight of the composition.

20. The method of claim 15, wherein the composition includes the hollow glass bubbles in an amount of 35 wt % or less and the glass fibers in an amount of 40 wt % or less by total weight of the composition.

21. An article of manufacture comprising the polypropylene of claim 1.

22. The article of manufacture of claim 21 comprising at least one of a telecommunication device, a component of a telecommunication device, a high frequency (>6 GHz) electrical device, a high frequency (>6 GHz) multi-generational telecommunication device, a component of a high frequency (>6 GHz) multi-generational telecommunication device, a 5G or higher generation telecommunication antenna and end-use device, a component of a 5G or higher generation telecommunication antenna and end use device, a telecommunication device housing, a radome cover, a radio-frequency (RF) filter, an RF connector, an EMI shield, an antenna substrate, a waveguide substrate, a waveguide carrier, an antenna substrate in a base station antenna, and an automotive radar component.
